(19) United States
(12) Patent Application Publication
(10) Pub. No.: US 2026/0229916 A1
(43) Pub. Date: Aug. 6, 2026

(54) AUTOMATIC TRANSFER PLUG

(71) Applicant: Joule Case Inc., Seattle, WA (US)

(72) Inventors: Alexander Livingston, Seattle, WA (US); John Ritchie, Seattle, WA (US)

(73) Assignee: Joule Case Inc., Seattle, WA (US)

(21) Appl. No.: 19/409,496

(22) Filed: Dec. 4, 2025

Related U.S. Application Data
(63) Continuation of application No. 17/824,616, filed on May 25, 2022, now abandoned.
Application No. 17/824,616 is a division of application No. 17/063,328, filed on Oct. 5, 2020, now abandoned.
(60) Provisional application No. 62/910,268, filed on Oct. 3, 2019.

(51) Int. Cl. H02J 9/06; H01H 3/22; H02J 9/08

(52) U.S. Cl. CPC H02J 9/068; H01H 3/22; H02J 9/062; H02J 9/066; H02J 9/08; H01H 2300/018

(57) ABSTRACT

A power management system for home, apartment, facility and building circuits includes a grid inter-active system comprising a cord, an electrical connection to an outlet, and a connection to an external power producing appliance. In addition, the system includes a communication or automatic interface associated with a system that detects power outages or other grid or time related event.

### RELATED APPLICATIONS

This application is a continuation of U.S. application Ser. No. 17/824,616 filed on May 25, 2022, which is a divisional of U.S. application Ser. No. 17/063,328 filed on Oct. 5, 2020, entitled “AUTOMATIC TRANSFER PLUG,” which claims the benefit of U.S. Provisional Patent Application No. 62/910,268, filed on Oct. 3, 2019, entitled “AUTOMATIC TRANSFER PLUG,” which applications are hereby incorporated by reference in their entireties as if they were fully set forth herein.

### TECHNICAL FIELD

This disclosure relates generally to electrical power systems, and more particularly to an automatic transfer switch (ATP) for safely transferring the source of power for a circuit from a primary power supply (e.g., a main grid) to a secondary power supply (e.g., a backup generator).

### BACKGROUND

Most households rely on the municipal and/or utility power grids to supply their home energy needs. These power grids typically utilize hydroelectric, nuclear, or fossil fuel power generation in order to supply a substantially constant and reliable source of electricity for homes, businesses, and public buildings.

In spite of the general reliability of municipal and utility power grids, there are instances in which the power grids are unable to supply electricity. For example, storms, earthquakes, accidents, maintenance, and equipment failure can all result in the interruption of the municipal power supply. In these situations, individuals and organizations may seek to implement backup or alternative power supply options.

When municipal/utility power is interrupted, the impact can be big or small, and the duration can be long or short. The cause of such power interruptions can be similarly diverse and distinct. No matter the cause or duration, power outages impact business, safety and health. Solutions to mitigate power outages often require complicated electronics or systems requiring building modifications that in turn require an electrician or professional services. In some cases, it may not be possible to make these modifications. For example, apartment dwellers or those occupying a space for a temporary period of time may be unable to make the necessary modifications to address power outages.

### SUMMARY

The present disclosure addresses the foregoing problem by providing a simple means to provide either seamless transition from utility power to another power source that does not require an electrical professional or modification to a building or dwelling. We describe a device (which may be in the form of a cord) that can transmit power from a power production appliance, device or multiple devices. The inventive system can produce power and transfer that power to a circuit or circuits thereby powering all devices and appliances plugged into that circuit. In many instances, the devices connected to the circuit might otherwise be impossible or very difficult to power without the aid of an electrician. Additional features of the inventive system are described below.

### BRIEF DESCRIPTION OF THE DRAWINGS

FIG. 1 depicts the inventive ATP in a micro-grid, with the ATP situated between a power generation appliance and a wall socket.

FIG. 2 is a block diagram on an illustrative embodiment of the inventive ATP.

FIG. 3 is an operational flow chart of an ATP, in accordance with embodiments discussed herein.

FIG. 4 depicts an ATP and various operational modes in accordance with embodiments.

FIG. 5 is an illustrative embodiment of an ATP configuration.

FIG. 6 is another illustrative embodiment of an ATP configuration.

FIG. 7 is an illustrative embodiment of a stackable ATP configuration.

FIGS. 8A and 8B illustrate ATP safety features in accordance with embodiments.

FIGS. 9A-9D illustrate additional ATP safety features in accordance with embodiments.

FIGS. 10A-10C illustrate an ATP configuration with circuit breaker features.

FIG. 11 is a block diagram of a power cell module, in accordance with embodiments.

FIG. 12 is an illustration of a power cell module, in accordance with embodiments.

FIG. 13 is an illustration of a system including a bank of power cell modules, in accordance embodiments.

### DETAILED DESCRIPTION OF ILLUSTRATIVE EMBODIMENTS

In the following, we disclose a systems, devices, and methods that can be employed to reduce or eliminate the need for an electrician to service and install new equipment in a home or require building modifications to provide seamless uninterrupted or backup power during an outage. The device is safe for all users in any circumstance and protects the power generation appliance used to provide backup and uninterruptible power.

The inventive device may be embodied in the form of cord that can transmit power from a power production appliance, device or multiple devices. The inventive device may produce power and transfer that power to a circuit, and thereby provide power to all devices/appliances plugged into that circuit. In many instances, the devices connected to the circuit might otherwise be impossible or very difficult to power without the aid of an electrician.

The disclosed device and process may be as simple as an electrical cord that plugs into the wall outlet with power provided from a grid independent appliance. Circuitry is provided to protect from voltage back-feed. This circuitry may be intelligent and when needed may allow for voltage to pass in correct and determined directions. Physical protection may include a shroud that covers the electrical connections from unintended electrical contact. A voltage sensing circuit may utilize contact relays. A process to disconnect or ‘break’ a particular circuit or set of circuits may be automatic and managed by voltage sensing devices to open a circuit breaker like that which would be commonly found in a building or house. This device may also be capable of opening the circuit and breaking the circuit from the greater grid. This device may be an addition to a circuit breaker or may be integrated into the circuit breaker itself. This portion of the overall system may simply require human interaction to open the circuit breaker of the desired circuit intended to be powered with the primary device.

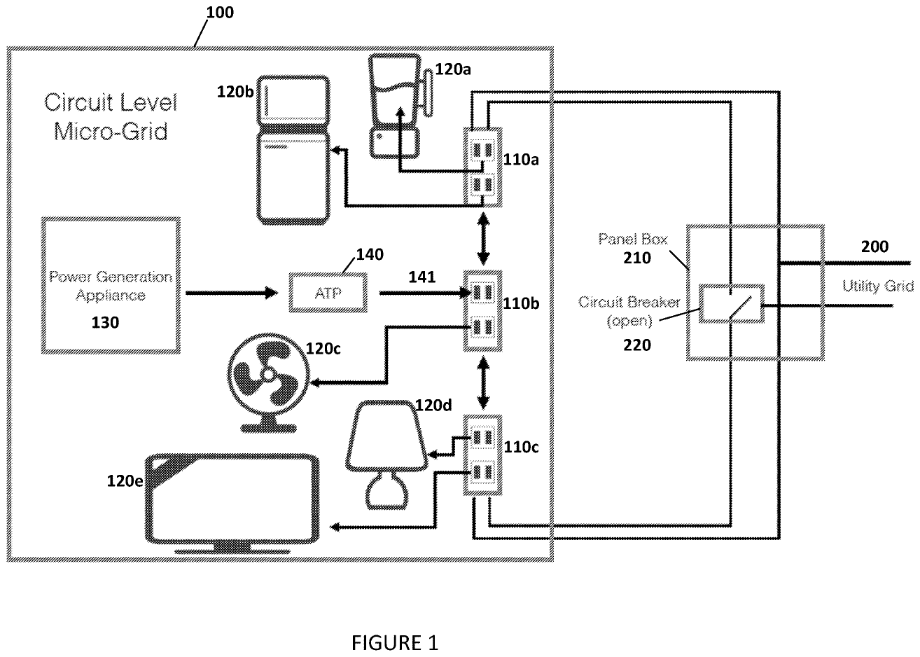

As shown in FIG. 1, the overall system includes a circuit level micro-grid 100 and a utility grid 200. The utility grid 200 may be a main power source for the overall system and provide electricity, for example, from a commercial power distribution system, a municipal power grid, a generator, boiler, or other source(s). The micro-grid 100 utilizes power from the utility grid 200 to provide energy to various systems and appliances. In examples, the micro-grid can be within a home, office, building, mobile system, vehicle, or any of a variety of applications applying power from the utility grid 200 to one or more applications.

In embodiments, a panel box 210 contains a circuit breaker 220, which is directly connected to the utility grid, and provides power to the micro-grid 100. In an embodiment, the micro-grid can include a number of wall sockets 110a, 110b, 110c, connected to circuit breaker. The circuit breaker 220 can contain electrical and mechanical components to ‘break’ the circuit based on an event. The ATP device may also be capable of reconnecting the circuit when power is restored. This can occur with or without user or application input.

The wall sockets 110a-c provide power access to a plurality of applications, such as electrical appliances 120a, 120b, . . . 120e. Such electrical appliances may be household appliances, such as a refrigerator, fan, television, electronics, lighting, a water heater, air conditioning, heat, etc.

A power generation appliance 130 may also be connected to a wall socket 110b, directly or indirectly. In embodiments, the power generation appliance 130 may include a battery or gas, diesel or other combustion fuel generator. The inventive ATP 140, as further discussed herein, can be coupled between the power generation appliance 130 and wall socket 110b. In general, the ATP is configured to prevent power from the utility grid 200 propagating back into the power generation appliance 130. The ATP is also configured to direct power from the power generation appliance 130 to any of the plurality of appliances 120a-e, such as in the case of a power outage and/or power loss.

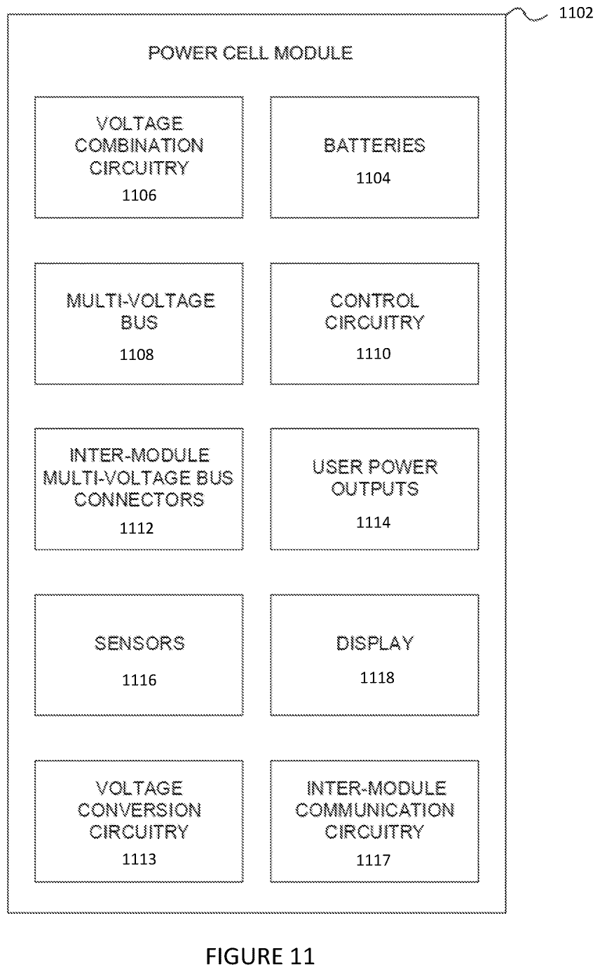

As shown, a cord or similar device 141 is used to connect the ATP 140 to the socket 110b. Such devices can also connect the ATP 140 to the power generation appliance 130 or be integrated with the power generation appliance. The power generation appliance 130 may be—but is not limited to—a modular power supply of the kind described in FIGS. 11-13, or U.S. patent application Ser. No. 16/443,266, “Modular Battery Pack System with Multi-Voltage Bus,” filed on Jun. 17, 2019. Any of a plurality of power generation appliance may be used in accordance with embodiments discussed herein.

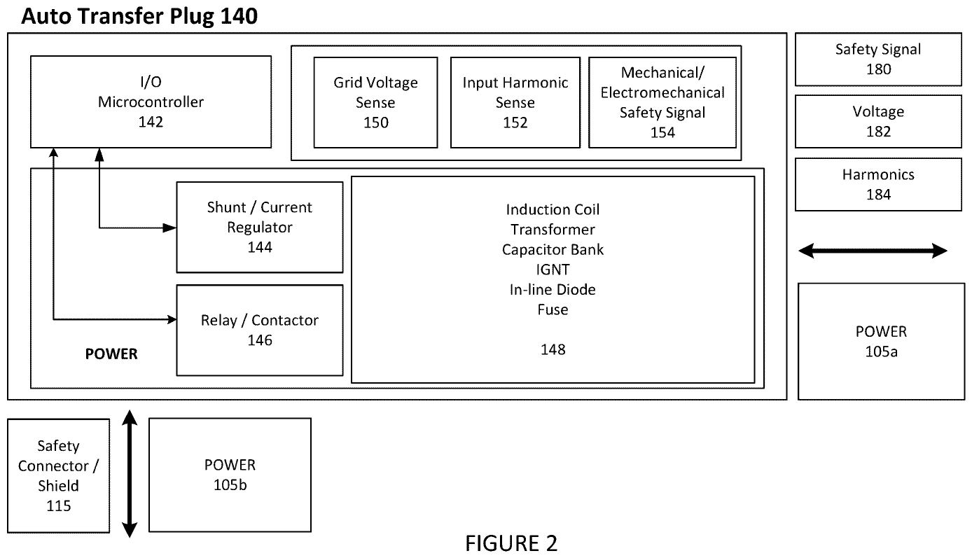

As shown in FIG. 2, an illustrative embodiment of the ATP 140 includes a microcontroller 142 having I/O capabilities and connected to a shunt/current regulator 144 and relay/contactor 146. In addition, as seen in block 148, the ATP can contain further contain circuitry and hardware comprising an induction coil, transformer, capacitor bank, insulated grate bipolar transistor (IGBT), in-line diode, and fuse. Such components assist in managing the power load and power transfer with the ATP 140 and the sources/appliances to which it is attached.

The ATP 140 both receives power and manages power pass through to one or more devices/appliances. There may be one or more connections, e.g., plugs, through which devices, such as Power 105a, 105b, may be connected to the ATP. These power sources can utilize US-style plugs, Anderson plugs, European plugs, Japanese plugs, USB ports, or any of a variety of plugs, ports, inputs, etc. in accordance with embodiments. Power generation appliance 130 or come from a utility power grid 200.

The connection between the ATP 140 and power source(s) 105 can further comprise a safety connector/shield 115, as discussed in embodiments herein. For example, the device (cord) 141 that connects into the wall may require a safe interface that first plugs into the wall outlet or socket 110b. This method provides a safe means for the user/operator to first plug the safety connector into a physically protected apparatus that may also mechanically and electro-mechanically signal the device has been properly connected to the circuit. The device or cord 141 can, for example, shield the ‘male’ plug from making unintended ‘contact’ with the user, operator or other to protect from an unintended ‘event’. The shield disengages when the male plug engages the socket or outlet on the circuit. Such features can protect the user, improve user functionality and interaction, improve connection security, and/or be modified for aesthetic purposes.

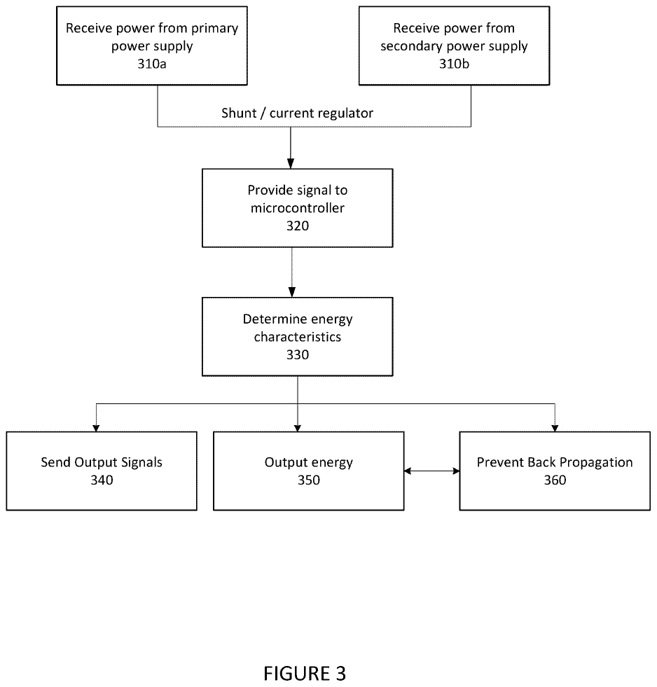

In embodiments, the microcontroller 142 receives signals from the shunt/current regulator 144 and relay/contactor 146 and is configured (with software or firmware) to sense the grid voltage 150 and harmonic frequencies, e.g., Input Harmonic Sense 152, as further described in FIG. 3. The microcontroller can further manage mechanical and/or electromechanical safety signals 154, such as producing output signals, such as a safety signal 180, voltage signals 182, and harmonic signals 184 as shown.

The ATP 140 uses directional voltage circuitry designed to restrict back-feed from the utility or grid circuit into the power generation appliance 130. This circuitry protects the higher voltage from the utility or grid from damaging the power generation appliance 130.

FIG. 3 illustrates a flow chart describing power pass through and management of the ATP. As discussed herein, power at the ATP 140 can be received via a primary power supply 310a, e.g., utility grid 200, or be received from a secondary power supply 310b, such as power generation appliance 130, or other appliance(s) connected to the ATP. The power can pass through a shut/current regulator, and signals are provided to the microcontroller 320, which then determines one or more energy characteristics 330. Such energy characteristics can relate to current, voltage, presence or absence of power from an input/output, a power mode of the ATP, a charging mode, grid voltage, harmonic frequencies, etc., and consequently manage power pass through and power output from the ATP.

In an embodiment, the ATP can send output signals 340 in response to determined energy characteristics. Such output signals can comprise safety signals 180, including but not limited to malfunctions, damage, voltage surges, and the like. Similarly, the ATP can send information regarding voltage signals, and harmonic signals. In various embodiments, such signals can be sent to and/or analyzed by one or more computing devices, used to provide feedback information, and utilized by one or more components on or connected to the ATP. Such output signals can be in the form of audio signals, e.g., a warning or alarm signal, visual signals, e.g., output on a display, data communication signals, and any of a variety or a combination of such signals, in accordance with embodiments.

The ATP can further regulate the output of energy 350 and prevent back propagation 360, e.g. back into the primary or secondary power source, or other appliance attached to the ATP. The output of energy 350 may be determined, for example, based on a mode that the ATP is set to. The microcontroller can further manage energy flow prevent back propagation that could damage any of the attached power sources or appliances, and/or deliver a particular amount of energy, such as an amount required to power an appliance. The output may be managed, similar to the output signals, by one or more hardware and/or software components on the ATP and/or connected to the ATP.

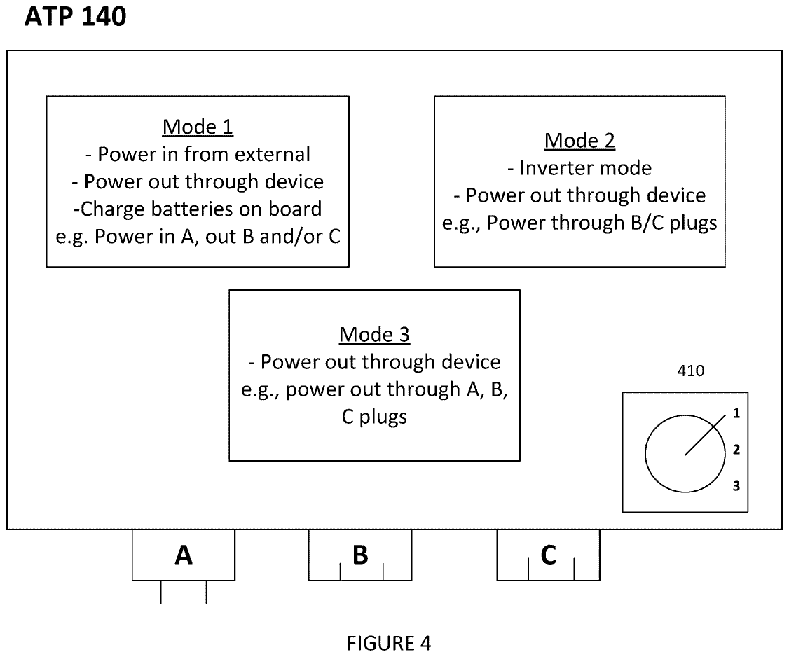

FIG. 4 illustrates various modes that the ATP 140 may execute, in accordance with embodiments discussed herein. The ATP can manage energy flow, input from, and output to a plurality of devices, e.g., power appliances, connected to the ATP. In the embodiment of FIG. 4, the ATP has three modes, and three connector plugs A, B, C. The modes of the ATP 140 may be selected via a dial 410. In other embodiments, the ATP mode may be set manually or automatically, through one or more physical switches and/or dials, or electronically, such as controlled via a remote controller operated by a computing device or a user.

In the depicted embodiment, the A connector is a male plug that can connect, for example to a wall outlet that is connected to a main power grid or utility grid. Connectors B and C can receive plugs from appliances or devices, such as devices to be charged. It will be appreciated that the ATP is not limited to the illustrated configurations and embodiments may comprise more or less modes of operation, as well as configured to attach to any of a plurality of appliances.

In a first mode, the ATP can be configured to receive power from an external power source, such as a utility grid, power generator, power generating appliance 130 or the like. The power can be received through the A plug. The ATP can manage power output, through the microcontroller and regulator, as discussed herein, and output power to one or more devices that may be connected to outlets B and/or C. In addition, the ATP can utilize the power received through inlet A to charge one or more batteries connected to and/or integrated with the ATP. As discussed herein, the ATP may be additionally connected to one or more batteries, power generating devices, or be integrated with such power generating devices. Thus, energy received at the ATP can be utilized to power such batteries and devices. Accordingly, should the power source connected to A be disconnected or shut off, as in Mode 2, the ATP is able to provide power out through one or more outlets B, C, and continue powering the one or more devices connected to the output channels.

Such a mode could be used, for example, in a home unit or small office. The ATP may be plugged into the local grid and allow pass through power to one or more items plugged into the deice when grid power is available. Accordingly, any encased batteries are charged and bypassed, with the local grid power powering the plugged-in devices. As applied to FIG. 4, for example, plug A would be connected to the power grid, and any power-drawings unit or appliance could be plugged into the C port. Voltage converters could be used as necessary on any of the ports A, B, C. The ATP device in this case could additionally comprise a control module with a base battery power, e.g., one or more power cell modules. Thus, the battery could be charged when receiving power, e.g., through Port A.

In a second mode, the ATP may act as an inverter. In this mode of operation, the ATP 140 is not receiving power from an external device or power source. However, the ATP can deliver power through the B and/or C outlets to power any connected devices. In embodiments, the ATP may be selective in discharging energy to one or more outlets, based on one or more energy characteristics and considerations, such as a power availability or the power required by devices connected to the outlets B, C.

In Mode 2, the A port may not plugged into the grid or if it is plugged in, not receiving any power from the grid. The device may already be charged to a Power Level. As such, any energy drawing devices connected to the module could be powered by the device. This Mode could simulate a power outage for example, when grid power or local power is cutoff. Thus the energy switches from the local/utility grid to local power stored at the ATP.

In a third mode, the ATP pushes power out through all plugs, A, B, and C. For example, if A is connected to a power grid, the ATP is able to push available power back into the power grid and provide energy for use by one or more devices further connected to the power grid. Similar to Modes 1 and 2, the ATP can push power out to any devices, batteries, appliances, etc., connected to outlets B and C. In this mode, the ATP is at its full functionality in delivering power to all outlets and connected devices. As discussed herein, the ATP 140 may have any of a plurality and combination of inputs/outputs and attachments, and further comprise one or more batteries integrated with the ATP from which it can draw power from, and subsequently output to connected devices.

This mode represents a reverse flow of power to a local circuit. In one example, during a power outage, the device could provide power to one or more items that are not easily plugged into a battery system directly, such as a refrigerator, or cannot be plugged in, such as a lighting system. The A port may be connected to the local grid/utility grid and push power back into the grid. Ports B and C are able to provide power to attached devices. Thus, energy is pushed out through all ports.

Accordingly, the ATP device may act as a multi-functional device, which can both receive and output power, and manage energy transfer and flow between connected devices. It will be appreciated that these modes provide but a few examples of the ATP's functionality and energy management capabilities, and can be configured based on the energy needs and requirements of the user and any attached appliances/power devices.

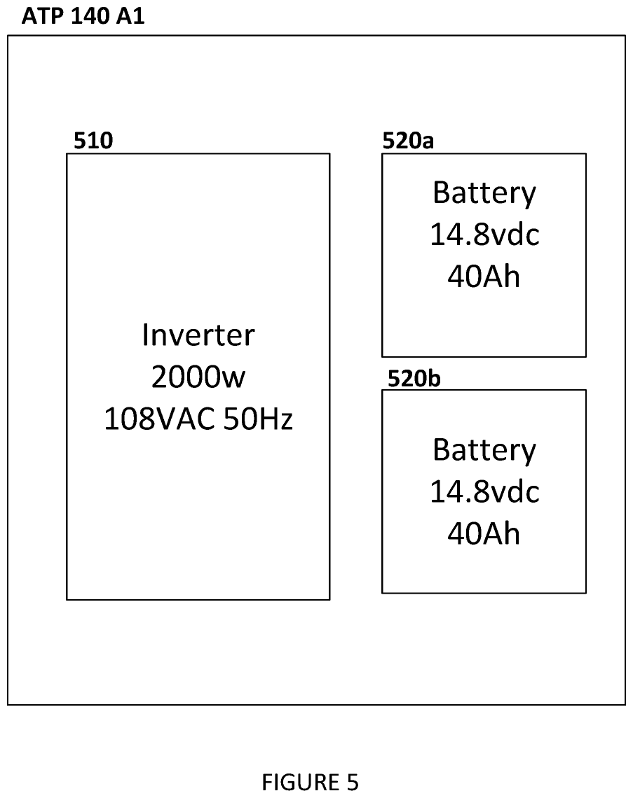

FIG. 5 illustrates another exemplary embodiment of an ATP. In this configuration the ATP 140A1 comprises an inverter 510, and two batteries 520a, 520b that are each integrated with the ATP and components discussed herein (see FIG. 2). In the ATP 140A1 embodiment, the inverter 510 may be 2000 W, with 108 VAC and 50 Hz. The batteries may have a 14/8 vdc and 40 Ah configuration. The size of the module may be 16.8″×9″ for example. It will also be appreciated, however, that the inverter and battery configurations are but one example of what may be utilized with an ATP embodiment, and the power configurations and capabilities of each may be adjusted based on desired power requirements and capabilities.

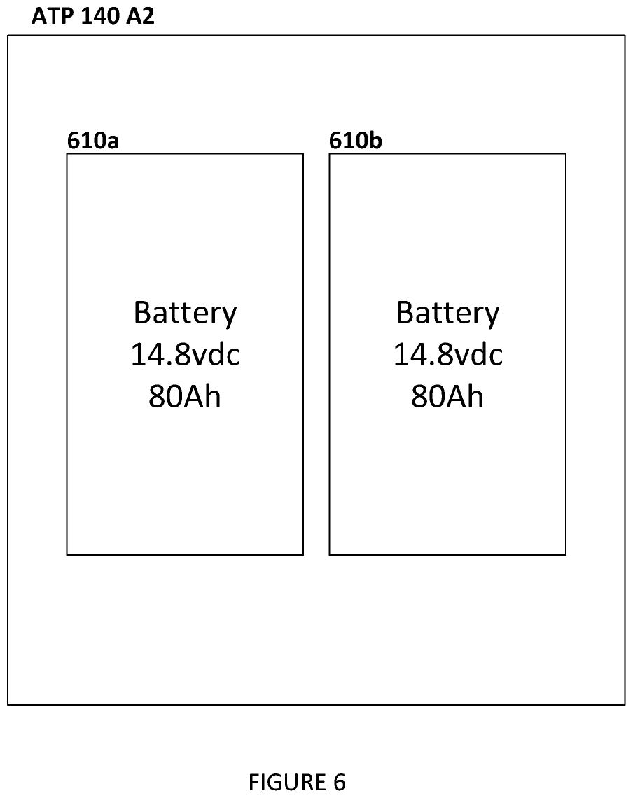

In the illustrated ATP example, the ATP 140A1 may incorporate one or more power cell modules (see FIGS. 11-13) into a single unit, enclosed in a casing. While the ATP 140A1 contains a plurality of batteries 520a, 520b, it is still capable of being connected to or stacked with additional batteries, such as additional ATP 140A1 modules or ATP 140A2 modules, as illustrated in FIG. 6. Any of the described configurations are capable of utilizing and delivering an uninterruptible power supply to the plurality of power appliances which may be connected to the ATP module.

FIG. 6 illustrates another example configuration of an ATP module. Here, the ATP 140A2 comprises two batteries 610a, 610b. While such batteries may be similar to the batteries 520a, 520b utilized in the ATP 140A1 of FIG. 5, such batteries can have a different configuration, such as a 14.8 vdc and 80 Ah configuration, and the ATP 140A2 can provide 4 kWh. It will be appreciated that the batteries on these ATP embodiments need not be the same, or be limited to two. The combination of batteries can be any of a variety of types and number of batteries, as discussed in various embodiments herein.

The ATP 140A2 embodiment similarly combines multiple battery modules, into a single unit. This unit can be connected to other ATP modules, such as ATP 140A1, and may be similarly sized, 16.8″×9″, to allow for compact and efficient stacking.

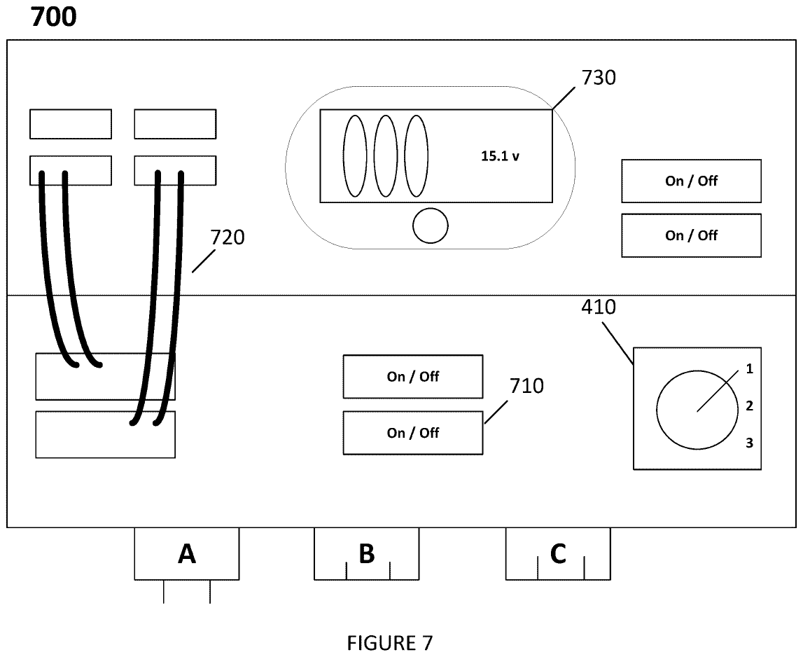

FIG. 7 illustrates an example of a stacked ATP configuration 700. Similar to the ATP Module discussed in FIG. 4, the ATP 700 can comprise a plurality of outlets, A, B, and C, which can receive or connect to external power appliances. The ATP 700 can comprise a dial 410 to alter the power mode of the configuration, and one or more On/Off switches 710 to control connection between the stacked ATP modules. For example, each power switch can control a single ATP module in the stack.

In an example in accordance with FIG. 7, primary DC connectors may be integrated with the product. Auxiliary and expandable connections are available, and connectors 720 can link the modules together. The configuration may be plugged into an outlet, for example, via Plug A. In embodiments, A may contain a light, LED, or other indicator to signify the receipt of power through the connector. In an embodiment, designation of a first mode via dial 410, can enable the power flow through via Plug A. The received power may be managed by the stack 700 and delivered through one or both Plugs B, C, depending on the designated mode of the ATP system. Additional modes may be available via a stacked configuration and the various lines can provide specific power outputs.

In one example, the ATP system can provide AC outputs, comprising Line 1, Neutral, and Ground. To create safe electrical flow, the ATP may require confirmation that an output device is safely and securely connected. In some embodiments, the desired circuit will need to have a “break” made, which can be made by the user or remote, e.g., via a remote controller. The ATP system can likewise have one or more AC Inputs, similarly comprising Line 1, Neutral, and Ground.

The system can provide a plurality of operation modes, as discussed herein, including but not limited to a Normal Grid Operation, a Power Outage Operation, and a Circuit/Uninterruptible Power Supply (UPS) backup. In a Normal Grid Operation, for example, a Relay to an AC input is closed. The ATP can recharge batteries on board and does so as part of its normal functioning. In this operational mode, UPS outlets (e.g., B, C are available).

In a Power Outage Operation, the AC from an external power source (e.g., a utility grid, power input through A, etc.) is stopped and the Relay opens. In this case, if the ATP is securely and safely connected to the desired circuit power can be delivered. If not, a break may occur, and a check can be performed. The check can occur automatically, e.g., after a signal of a break is received, and done via a computing device. Alternatively, a signal of a break occurring can require a manual “check” operation by a user, technician, or other operator.

The ATP may also provide a Circuit and UPS backup operation wherein once a break input has been received, power is able to flow to the UPS outlets (e.g., B, C) and back into the circuit that had previously provided grid power.

The stackable design allows various power modules to efficiently combine and create different combinations, tailored to specific energy requirements. As such, embodiments discussed herein may be applied to a variety of types of devices, ranging from small robots, personal mobility devices, home, office, and industrial systems, mobilized battery systems, and can even be utilized on a larger scale in utility grids. In addition, the stackable design can fit within a module or encasing that encompasses the stack of ATP and/or power cell modules, thus increasing mobility and portability of the system as a whole.

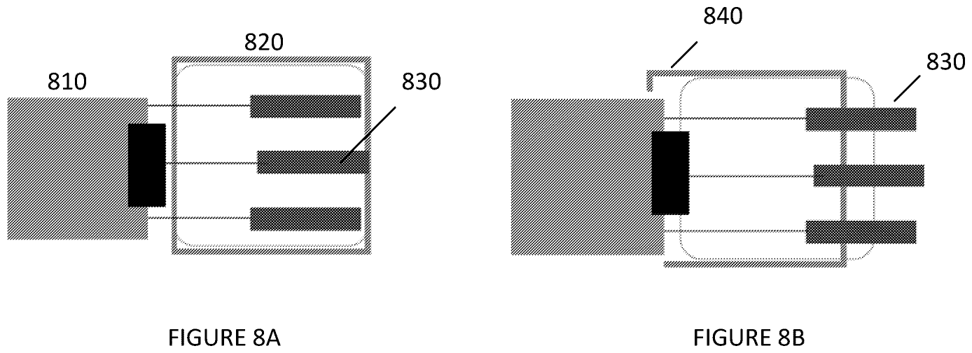

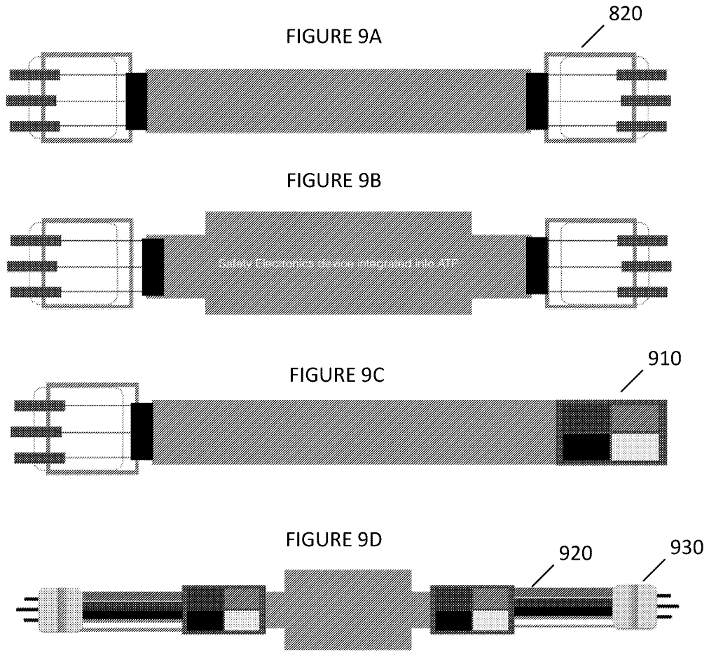

FIGS. 8-9 illustrate ATP embodiments comprising additional features, such as a safety shroud, safety electronics combinations, and a remote controllable circuit breaking device. As seen in FIGS. 8A-8B, cord 810 is adjacent to a shroud or shield 820 that contains electrical prongs 830. The embodiment illustrates a safe connection trigger, which allows electrical prongs 130 to be safely inserted into an outlet. FIG. 8A illustrates the retracted version, wherein the electrical prongs 830 are contained within the shroud/shield 820 when the device is not connected to an outlet. In this safety mode, the electrical prongs 830 are covered and not exposed. This reduces the risk of accidental exposure or contact by a user or technician and decreases likelihood of shock, injury, unintended event, or damage to the electrical prongs when not in use, i.e., plugged into an outlet or device.

In FIG. 8B, the shroud shifts to a retracted position 840 to expose the electrical prongs 830, and allow the prongs to be plugged into an outlet or device. Thus, the electrical prongs can be engaged only when the shroud cover/shield is pulled back. Accordingly, these features provide a safe means for the user/operator to first plug the safety connector into a physically protected apparatus that may also mechanically and electro-mechanically signal the device has been properly connected to the circuit. The shroud/shield then disengages when the male plug engages the socket or outlet on the circuit.

FIG. 9 illustrates various embodiments on which the safety features described herein may be implemented. FIG. 9A illustrates a shroud 820, in accordance with FIGS. 8A-8B, on a connector having male/male ends. FIG. 9B illustrates an example embodiment wherein the safety shroud/shield is implemented on a device integrated into an ATP. FIG. 9C illustrates an ATP embodiment wherein a shrouded male connector is on one end, and a safe contact connector is on the opposite end. FIG. 9D illustrates an example wherein the ATP has multiple disconnection points, safety electronics 910, 920, and a live end indicator 930. In the example illustrated in FIG. 9D, the male connector does not have a shield/shroud. It will be appreciated that any combination of safety features and devices discussed herein, with respect to FIGS. 8-9 may be implemented on connections. For example, any or all of the shield/shrouds 830, safety electronics 910, 920, and live end indicators 930 may be implemented with one another.

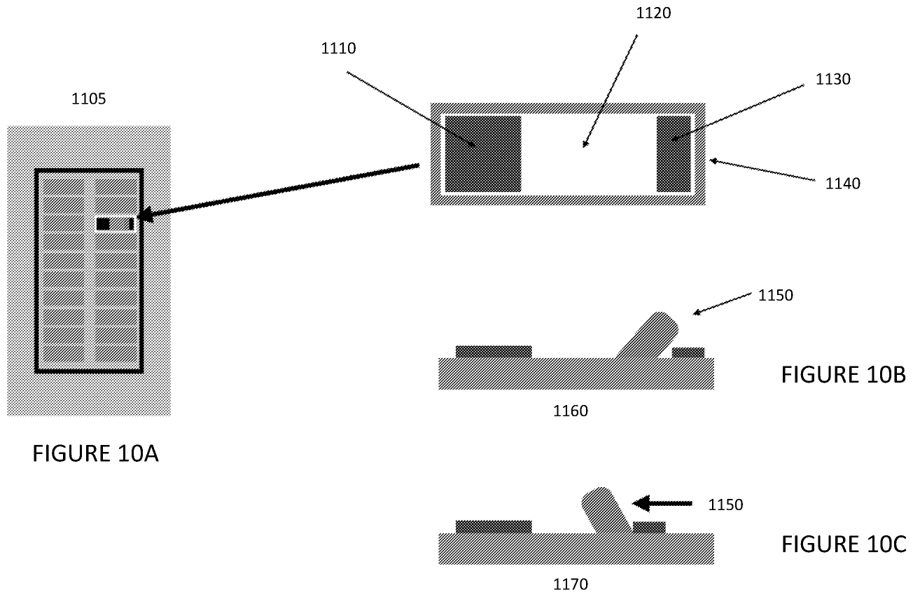

FIGS. 10A-10C illustrate a configuration wherein one or more ATP devices can be fixed inside a module or panel box 1105, and comprise a circuit breaker. ATP devices in the present configuration can each comprise a communication/logic board 1110, an empty area 1120 e.g., for a circuit breaker paddle, a paddle trip device 1130, and a rigid outer frame 1140. In accordance with embodiments, such ATP devices can be stackable and combinable to form an integrated combination that meets the power needs of its intended use.

FIG. 10B illustrates a circuit breaker paddle 1150 in a “Grid Available” operation 1160, wherein the circuit is open and functional. FIG. 10C illustrates a grid fail operation 1170 wherein the circuit breaker paddle 1150 has been tripped. The tripped circuit breaker paddle 1150 can be switched automatically, manually, or by other command input to restore functionality back to the “Grid Available” configuration of FIG. 10B.

FIG. 11 is a block diagram of a power cell module 1102, according to an embodiment. The power cell module 1102 includes a plurality of batteries 1104, voltage combination circuitry 1106, a multi-voltage bus 1108, control circuitry 1110, inter-module multi-voltage bus connectors 1112, user power outputs 1114, voltage conversion circuitry 1113, inter-module communication circuitry 1117, sensors 1116, and a display 1118, according to various embodiments. The components of the power cell module 1102 enable the power cell module 1102 to function as a standalone power supply or to connect with other power cell modules as part of a bank or stack of power cell modules that collectively provide electricity to one or more electronic appliances.

In one embodiment, the power cell module 1102 includes a plurality of batteries 1104. The batteries 1104 can include one or more of lead acid batteries, lithium-ion batteries, Nickel-Zinc batteries, Nickel-Cadmium batteries, Nickel-metal-hydride batteries, and Zinc-Magnesium oxide batteries. In one embodiment, each of the batteries 1104 within a given power cell module 1102 is a same type of battery. Alternatively, in some embodiments, the batteries 1104 in a given power cell module 1102 can include multiple types of batteries.

In one example, in accordance with one embodiment, the power cell module 1102 includes four individual batteries 1104. The individual batteries 1104 include 12 V lead acid batteries. The power cell module 1102 utilizes the 12 V lead acid batteries to provide electricity to one more electronic appliances either as a standalone power cell module 1102, or as part of a bank or stack of power cell modules 1102 that collectively provide electricity to one or more electronic appliances.

In one embodiment, the power cell module 1102 includes voltage combination circuitry 1106. The voltage combination circuitry 1106 is coupled to the terminals of the batteries 1104 in order to provide, simultaneously, multiple output voltages from the batteries 1104. The output voltages provided by the voltage combination circuitry 1106 correspond to various series and parallel connections of the batteries 1104. Thus, each output voltage provided by the voltage combination circuitry 1106 corresponds to a parallel connection of multiple of the batteries 1104, a series connection of multiple of the batteries 1104, or a combination of series and parallel connections of multiple of the batteries 1104.

In one embodiment, the voltage combination circuitry 1106 provides the multiple output voltages simultaneously. For example, the voltage combination circuitry 1106 can include one set of terminals that provide an output voltage that is a series connection of all the batteries 1104, one set of terminals that provides an output voltage that is a parallel connection of all of the batteries 1104, and a set of terminals that provides an output voltage that is a parallel connection of two sets of batteries wherein each set of batteries is a series connection of two or more of the batteries 1104.

In one embodiment, the voltage combination circuitry 1106 includes circuit components among the various connections that prohibit short-circuits among the various output voltages. For example, the connection between two terminals of two of the batteries 1104 can include one or more diodes configured to prohibit the flow of current in an undesired direction. This can ensure that the voltage combination circuitry 1106 can provide various combinations of voltages without short-circuiting and without the need of a multiplexer, according to one embodiment.

In one embodiment, the voltage combination circuitry 1106 provides all the output voltages simultaneously. The voltage combination circuitry 1106 does not generate the various output voltages via transformers, voltage multipliers, or charge pumps, according to an embodiment. Instead, the voltage combination circuitry 1106 provides each output voltage as series, parallel, or series and parallel connections between the various terminals of the batteries 1104, according to one embodiment.

In one embodiment, the power cell module 1102 includes a multi-voltage bus 1108. The multi-voltage bus 1108 receives the output voltages from the voltage combination circuitry 1106. The multi-voltage bus 1108 includes a plurality of voltage lines, one for each output voltage of the multi-voltage bus 1108. Thus, each voltage line of the multi-voltage bus 1108 carries a voltage corresponding to one of the respective output voltages from the voltage combination circuitry 1106. Accordingly, the multi-voltage bus 1108 simultaneously carries all output voltages from the voltage combination circuitry 1106, according to an embodiment.

In one embodiment, the multi-voltage bus 1108 is designed so that when the power cell module 1102 is connected in a bank of power cell modules, the multi-voltage bus 1108 connects to a corresponding multi-voltage bus from all of the power cell modules of the bank of power cell modules. Accordingly, when the power cell module 1102 is connected in a bank of power cell modules, the bank of power cell modules has a collective multi-voltage bus that is the continuation of each of the multi-voltage buses of the various power cell modules of the bank of power cell modules.

In one embodiment, when the power cell module 1102 is connected to a second power cell module, each line of the multi-voltage bus 1108 is electrically connected to a corresponding line of a multi-voltage bus of the second power cell module. If the multi-voltage bus 1108 includes three lines each carrying either a respective output voltage V1, V2, or V3, when the power cell module 1102 is connected to the second power cell module, the V1 line of the multi-voltage bus 1108 is connected to the V1 line of the multi-voltage bus of the second power cell module, the V2 line of the multi-voltage bus 1108 is connected to the V2 line of the multi-voltage bus of the second power cell module, and the V3 line of the multi-voltage bus 1108 is connected to the V3 line of the multi-voltage bus of the second power cell module. Accordingly, the multi-voltage bus 1108 of the modular battery power cell 1102 and the multi-voltage bus of the second power cell module form a collective multi-voltage bus including the V1 line, the V2 line, and V3 line. Each additional power cell module connected into the bank of power cell modules joins the collective multi-voltage bus. Each power cell module provides V1, V2, and V3 to the collective multi-voltage bus.

In one embodiment, the advantage of the multi-voltage bus is that users do not need to manually control the power cell modules to provide a particular desired voltage. If this were not the case, then it is possible that each power cell module would need to be manually or electronically configured by the user in the exact same way to avoid short-circuits or other electrical problems that can come with mismatched voltage connections between the various power cell modules. Instead, each power cell module, in accordance with one embodiment, provides all voltages and contributes to the collective multi-voltage bus. As will be set forth in greater detail below, this enables a very simple set up that requires little or no electrical knowledge from users before they can safely and effectively use the power cell modules either individually or in a bank of power cell modules.

In one embodiment, the power cell module 1102 includes control circuitry 1110. The control circuitry 1110 can include one or more processors or microcontrollers that control the operation of the power cell module 1102. The one or more processors can execute software instructions stored in one or more memories in order to control the functionality of the various aspects of the power cell module 1102. The one or more processors can also be controlled via manual interaction or wireless communication controlled inputs. The control circuitry 1110 can operate in accordance with firmware stored in the one or more memories.

In one embodiment, the control circuitry 1110 is able to selectively connect or disconnect the voltage combination circuitry 1106 from the multi-voltage bus 1108. For example, if the batteries 1104 are depleted, or in a fault state, that the control circuitry 1110 can operate switches are circuit breakers that disconnect the output voltages of the voltage combination circuitry 1106 from the multi-voltage bus 1108.

In one embodiment, the power cell module 1102 includes sensors 1116. The sensors 1116 sense various aspects of the power cell module 1102. The sensors 1116 provides sensor signals to the control circuitry 1110. The control circuitry 1110 can control the components and functionalities of the power cell module 1102 responsive to the sensor signals from the sensors 1116 and in accordance with internal logic of the control circuitry 1110. For example, the control circuitry 1110 can disconnect the voltage combination circuitry 1106 from the multi-voltage bus 1108 responsive to the sensor signals.

In one embodiment, the sensors 1116 can include multiple sensors that sense the voltages output by each battery 1104. The voltage sensors can output sensor signals to the control circuitry 1110 indicative of the voltage outputs of each battery. The voltage sensors can also sense the output voltages provided by the voltage combination circuitry 1106 and can provide sensor signals to the control circuitry 1110 indicative of the output voltages provided by the voltage combination circuitry 1106. The control circuitry 1110 can control components and functionality of the power cell module 1102 responsive to the sensed voltages. In one embodiment, the voltage sensors are part of the control circuitry 1110. Alternatively, the voltage sensors can be external to the control circuitry 1110.

In one embodiment, the sensors 1116 can include current sensors. The current sensors can sense the current flowing from each of the batteries 1104. The current sensors can sense the total current flowing from the power cell module 1102. The current sensors can also sense the current flowing from the batteries 1104 through each line of the multi-voltage bus 1108. The current sensors output sensor signals to the control circuitry 1110 indicative of the various currents flowing in and from the power cell module 1102. The control circuitry 1110 can control components and functionality of the power cell module 1102 responsive to the sensed currents. In one embodiment, the current sensors are part of the control circuitry 1110. Alternatively, the current sensors can be external to the control circuitry 1110.

In one embodiment, the sensors 1116 can include temperature sensors. The temperature sensors can sense the temperatures of the batteries 1104. The temperature sensors can sense a temperature within the power cell module 1102. The temperature sensors can also sense the temperature of various components within the power cell module 1102. The temperature sensors can output sensor signals indicative of the various temperatures to the control circuitry 1110. The control circuitry 1110 can then take action responsive to the temperatures. For example, the control circuitry 1110 can disconnect the voltage combination circuitry 1106 from the multi-voltage bus 1108 to stop the flow of current in response to an indication that the batteries 1104 overheating.

In one embodiment, the power cell module 1102 includes user power outputs 1114. The user power outputs 1114 include various ports each outputting a particular voltage. For example, the user power outputs 1114 can include one or more output ports for each voltage carried by the multi-voltage bus 1108. A user can connect an electronic appliance to one of the output ports in order to provide power to the electronic appliance. The user can connect the electronic appliance to the output port that carries the correct voltage for the electronic appliance. The power cell module 1102 can also include user power inputs that can receive electrical connections to provide power to the power cell module 1102.

If the multi-voltage bus 1108 includes three output voltages V1, V2, and V3, the user power outputs 1114 can include multiple output ports for each output voltage. Each output port can correspondence to a particular type of connection. Accordingly, there may be multiple types of output ports for a single output voltage to fit multiple types of electrical connectors for electronic appliances. In one embodiment, the user power outputs 1114 can receive dongles or adaptors that fit the output ports to particular common connection schemes. In one embodiment, if an electronic appliance requires a DC voltage other than those carried by the multi-voltage bus 1108, then an adapter can be plugged into one of the output ports, receive the voltage from the output port, and step the voltage up or down in order to achieve the voltage required by the electronic appliance.

In one embodiment, when the power cell module 1102 is connected in a bank of power cell modules, if a user plugs an electronic appliance into one of the user power outputs 1114, power is provided to the electronic appliance from each power cell module connected to the multi-voltage bus 1108. Thus, when an electronic appliance is plugged into the power output of one power cell module in a bank of power cell modules, the electronic appliance draws a portion of the overall current from each power cell module connected to the multi-voltage bus 1108. Thus, large numbers of power cell modules can be connected in a bank so that a particular electronic appliance, or several electronic appliances, can be powered for a long time by the bank of power cell modules.

In one embodiment, the power cell module 1102 includes voltage conversion circuitry 1113. The voltage conversion circuitry 1113 is connected to one or more of the voltage lines of the multi-voltage bus 1108. The voltage conversion circuitry 1113 receives one or more output voltages from the multi-voltage bus 1108 and generates other voltages. The other voltages can include DC voltages intermediate to the output voltages of the multi-voltage bus 1108, greater than the highest voltage carried by the multi-voltage bus 1108, less than the smallest voltage carried by the multi-voltage bus 1108, and voltages of a different type than the voltages carried by the multi-voltage bus 1108. The user power outputs 1114 can include one or more output ports for each voltage generated by the voltage conversion circuitry 1113. This enables users to plug electronic appliances into output ports that carry voltages other than those carried by the multi-voltage bus 1108.

In one embodiment, because the voltages generated by the voltage conversion circuitry 1113 are generated from the multi-voltage bus 1108, electronic appliances that receive voltages generated by the voltage conversion circuitry 1113 draw power from each of the power cell modules connected to the multi-voltage bus 1108.

In one embodiment, the voltage conversion circuitry 1113 receives a DC voltage from the multi-voltage bus 1108 and generates an AC voltage. The AC voltage is then provided to one or more of the user power outputs 1114. Accordingly, the voltage conversion circuitry 1113 can include one or more inverters to generate one or more AC voltages. In one embodiment, one of the AC voltages has an amplitude and frequency corresponding to the amplitude and frequency of a local municipal power grid. For example, one of the AC voltages can include 1110 V AC at 60 Hz, corresponding to standard wall voltage in North America and many other areas. Another AC voltage can include 220 V AC at 60 Hz, corresponding to the increased voltage at which some electronic appliances operate in North America and many other areas.

In one embodiment, in the event of a failure of the municipal power grid, electronic appliances that normally plug into the wall voltage, or into the higher than wall voltage, can be plugged into the power cell module 1102 or can otherwise receive power from the power cell module 1102. If the power cell module 1102 is connected in a bank of a large number of power cell modules, then the AC powered electronic appliances can draw power from all of the power cell modules that are connected to the multi-voltage bus 1108. In one embodiment, the system can be plugged into a standard wall outlet of a house when the municipal power grid is interrupted and is not supplying power. A power chord can be plugged into the wall outlet from one of the power cell modules. The power cell module converts one of the DC output voltages from the multi-voltage bus into an AC voltage having the correct frequency and amplitude for the wall outlet. The AC voltage is then supplied to the wall outlet. All of the wall outlets that are on the same circuit can now be powered by the AC voltage supplied from the power cell module or bank of power cell modules. Before doing this, the user will need to access the circuit box and trip the circuit breaker to that circuit so that if the municipal power grid comes back online there will not be a short circuit. The power cell module can include protective circuitry to protect the power cell module in the event of a short circuit. The power can be supplied via a bank of power cell modules.

In one embodiment, the voltage conversion circuitry 1113 can receive a voltage from the multi-voltage bus 1108 and can convert the voltage to one or more voltages associated with typical personal electronic device connectors. For example, many electronic devices are powered by a specified small voltage, such as 3.1 V or 5 V. Many electronic devices are adapted to receive voltages from standardized output ports such as USB 2.0, USB 3.0, micro USB, USB C, or other types of charging ports. The voltage conversion circuitry 1113 can generate the voltages associated with these types of charging ports. The user power outputs 1114 can include multiple charging ports that fit the various standard ports and that receive the proper voltages from the voltage conversion circuitry 1113. Users can then plug their personal electronic devices, such as mobile phones, tablets, ear phones, game controllers, wearable electronic devices, drones, and other kinds of personal electronic devices that can be charged from a standard output port, into the corresponding output ports of the user power outputs 1114 in order to charge their personal electronic devices.

In one embodiment, the power cell module 1102 includes a display 1118. The display 1118 can output data or other messages indicating a current state of the power cell module 1102. The display 1118 can indicate the number of power cell modules connected in a bank of power cell modules. The display 1118 can indicate the current level of charge in the batteries 1104, an indication of the current or power being output by the power cell module 1102, or a length of time until the batteries 1104 need to be recharged at the current power draw. The display 1118 can indicate whether there is a fault condition associated with the power cell module 1102. The display 1118 can provide instructions to a user for initializing, utilizing, or troubleshooting the power cell module 1102. The display 1118 can provide data indicating which of the user power outputs 1114 is currently in use. The display 1118 can provide information such as the temperature within the power cell module 1102 or the voltage levels of the batteries 1104.

In one embodiment, the control circuitry 1110 can control the display 1118. The control circuitry 1110 can output messages to the user via the display 1118. The control circuitry 1110 can output instructions to the user for operating the power cell module 1102 or for providing the current status of the power cell module 1102 to the user. The display can also display information pushed to other power cell modules or connected electronic devices.

In one embodiment, the power cell module 1102 includes inter-module multi-voltage bus connectors 1112. The inter-module multi-voltage bus connectors 1112 electrically connect the voltage lines of the multi-voltage bus 1108 to the corresponding voltage lines of a second power cell module. The inter-module multi-voltage bus connectors 1112 can include Anderson connectors or other types of standard or unique connectors that can couple the voltage lines of the multi-voltage bus 1108 to the corresponding voltage lines of the multi-voltage bus of a second power cell module.

In one embodiment, the inter-module multi-voltage bus connectors 1112 automatically connect the voltage lines of the multi-voltage bus 1108 to the corresponding voltage lines of a second power cell module when the power cell module 1102 is attached to the second power cell module. Accordingly, the inter-module multi-voltage bus connectors 1112 can include fasteners that assist in securely fastening the power cell module 1102 to a second power cell module when stacked together.

In one embodiment, the power cell module 1102 includes inter-module multi-voltage bus connectors 1112 on top and bottom surfaces of the power cell module 1102. Thus, when the power cell module 1102 is connected in a bank of power cell modules 1102, the power cell module 1102 can be connected to a second power cell module below the power cell module 1102, and a third power cell module can be connected to the top of the power cell module 1102. In one embodiment, the power cell module 1102 can include latches, releases, and other connection hardware that enables the power cell module 1102 to quickly attach to other power cell modules and to quickly be released from other power cell modules.

In one embodiment, the power cell module 1102 includes inter-module communication circuitry 1117. The inter-module communication circuitry 1117 enables the power cell module 1102 to communicate with other power cell modules in a bank of power cell modules in which the power cell module 1102 is connected. The inter-module communication circuitry 1117 can share the status or condition of each power cell module. In one embodiment, the inter-module communication circuitry 1117 includes wireless transceivers enabling the power cell modules to communicate with each other wirelessly. In one embodiment, the inter-module communication circuitry 1117 includes wired connections that enable the power cell modules to communicate with each other across wired connections. In one embodiment, the inter-module communication circuitry can enable the power cell module 1102 to establish which power cell module in a bank of connected power cell modules is the master or controlling power cell module.

In one embodiment, the inter-module communication circuitry can communicate with one or more users. For example, the inter-module communication circuitry 1117 can send alerts to the user regarding the current state of the inter-power cell module 1102, or the bank of inter-power cell modules. The inter-module communication circuitry 1117 can alert the user when the overall capacity of the bank of power cell modules is low so that the user can recharge power cell modules or make other provisions for powering electronic appliances. In one embodiment, the users can install a dedicated power cell module system application on a personal computing device, such as a smart phone. The power cell module system application can enable the user to control or otherwise communicate with the power cell modules.

In one embodiment, when the power cell modules are connected in a bank of power cell modules, one of the power cell modules can be designated as the master power cell module. Users can be directed to connect electronic appliances to the master power cell module, the electronic appliances can then be powered by the entire bank of power cells via the master power cell. In one embodiment, the master power cell is substantially the same as the other power cell modules in the bank power cells. Alternatively, the master power cells can be a different type of power cell that includes additional connections and functionality.

In one embodiment, the power cell module 1102 includes a casing. The components of the power cell module one 1102 are positioned primarily within the casing. The display 1118 and the user power outputs 1114 can be positioned on an outer surface of the casing. The inter-module multi-voltage bus connectors 1112 can also be positioned, at least partially, and an outer surface of the casing. Inter-module data connection ports and other I/O ports can be positioned on the outer surface of the casing.

Those of skill in the art will recognize, in light of the present disclosure, that a power cell module 1102 in accordance with the present disclosure can include additional components, fewer components, or different combinations of components than are shown in FIG. 11, without departing from the scope of the present disclosure.

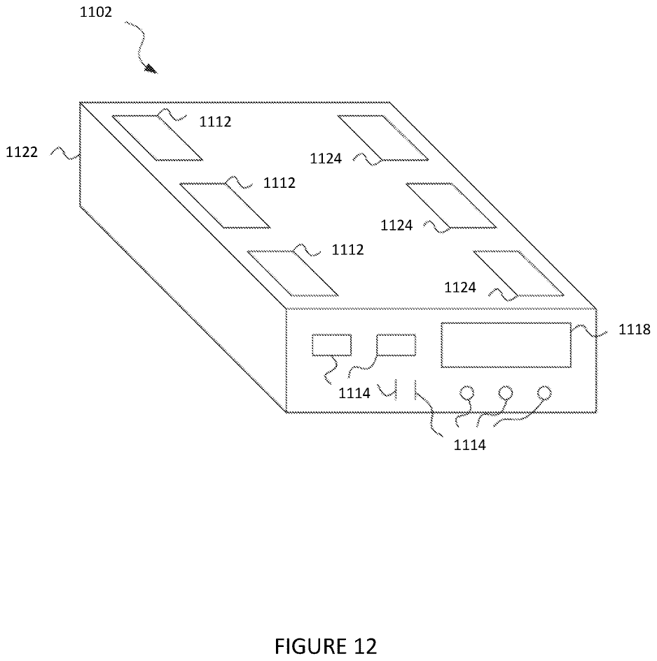

FIG. 12 is an illustration of a power cell module 1102, according to an embodiment. With reference to FIG. 11 and the descriptions above, the power cell module 1102 includes a casing 1122. The casing 1122 houses the batteries 1104a-1104d, the voltage combination circuitry 1106, the control circuitry 1110, the sensors 1116, the multi-voltage bus 1108, and other internal components of the power cell module 1102.

In one embodiment, the casing 1122 is formed of a durable material that can withstand the weight of several power cell module stacked on top of it. The material of the casing is also selected to withstand portable use of the power cell module 1102. The casing 1122 can include a hard and durable plastic, according to an embodiment.

In one embodiment, the inter-module multi-voltage bus connectors 1112 are positioned on the top surface of the power cell module 1102. Though not shown in FIG. 12, inter-module multi-voltage bus connectors 1112 are also positioned on a bottom surface of the power cell module 1102.

In one embodiment, when a power cell module is stacked on top of the power cell module 1102, the inter-module multi-voltage bus connectors 1112 on the top surface of the power cell module 1102 connect with inter-module multi-voltage bus connectors on a bottom surface of the other power cell module. The inter-module multi-voltage bus connectors 1112 ensure a secure electrical connection of the voltage lines of the output voltages of the multi-voltage bus 1108 of each of the power cell modules, forming a collective multi-voltage bus from all of the power cell modules in a stack. Additionally, though not shown, inter-module multi-voltage bus connectors 1112 can also be positioned on lateral surfaces of the power cell module 1102 to facilitate stacking or connecting power cell modules laterally as well as vertically.

In one embodiment, the inter-module multi-voltage bus connectors 1112 can include Anderson connectors. Additionally, or alternatively, the inter-module multi-voltage bus connectors 1112 can include other types of electrical connectors. Each inter-module multi-voltage bus connector 1112 can include a positive and a negative terminal for the corresponding output voltage. In one embodiment, the inter-module multi-voltage bus connectors 1112 can also include fasteners that securely fasten power cell module 1102 to the power cell module that is placed on top of the power cell module 1102, or on top of which the power cell module 1102 is placed, as the case may be.

In one embodiment, the power cell module 1102 also includes fasteners 1124 on the top and bottom surfaces of the power cell module 1102. The fasteners 1124 can assist in fastening the power cell module 1102 to a power cell module placed on top of the power cell module 1102 the fasteners 1124 can assist in fastening the power cell module to a power cell module placed on the bottom of the power cell module 1102.

In one embodiment, the power cell module 1102 also includes user power outputs 1114 on a front face of the power cell module 1102. User power outputs 1114 can also be positioned on other faces of the power cell module 1102. Users can connect electronic appliances to the user power outputs 1114 in order to power electronic appliances with the power cell module 1102, or with a stack of power cell modules.

In one embodiment, the power cell module 1102 can also include user input devices, not shown in FIG. 12. The user input devices can enable the user to input commands or otherwise control features of the power cell module 1102. The user input devices can include buttons, switches, sliders, knobs, keypads, touchscreens, or other devices by which users can input commands or control features of the power cell module 1102. In one embodiment, the user input devices include a power button that enables the user to turn the power cell module 1102 on or off.

In one embodiment, the power cell module can also include data ports, not shown in FIG. 12. The data ports can include connectors for reading data from or writing data to a memory within the power cell module 1102.

In one embodiment, the power cell module 1102 includes a display 1118. The display 1118 can display text, images, or animations. The user can read or view the text, images, or animations displayed by the display 1118.

Those of skill in the art will recognize, in light of the present disclosure, that the power cell module in accordance with principles of the present disclosure can have other shapes and configurations than that which is shown in FIG. 12, without departing from the scope of the present disclosure.

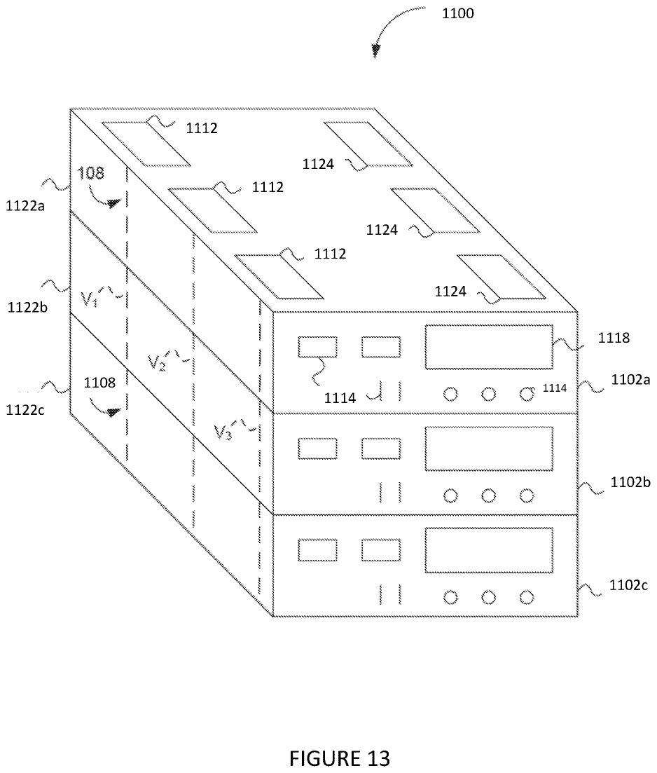

FIG. 13 illustrates a energy storage and supply system 1100 including a bank of power cell modules 1102a-1102c, according to one embodiment. With reference to the descriptions above, FIG. 13 illustrates three power cell modules 1102a-1102c. However, more or fewer power cell modules can be connected in a bank of power cell modules in accordance with principles of the present disclosure.

In one embodiment, each power cell module the bank of power cell modules is connected in such a manner that a collective multi-voltage bus 1108 is formed. The collective multi-voltage bus 1108 includes a voltage line for each output voltage V1-V3. The collective multi-voltage bus 1108 simultaneously carries each of the output voltages V1-V3.

In one embodiment, when an electronic appliance is connected to one of the user power outputs 1114 of one of the power cell modules 1102a-1102c, power is provided to the electronic appliance from each of the power cell modules 1102a-1102c. The voltage lines of the multi-voltage bus 1108 are shown as dashed lines internal to the casings 1122a-1122c of the power cell modules 1102a-1102c. While each output voltage is shown as having a single line, in practice, each output voltage has both a positive and a negative line defining the output voltage.

In one embodiment, each power cell in the system 1100 is substantially identical, having the same user power outputs 1114, the same display 1118, and possibly other identical features such as user inputs and data ports. In this case, power can be supplied by plugging an electronic appliance into the user power outputs 1114 of any of the connected power cell modules 1102a-1102c. Alternatively, one of the power cell modules can act as a master to the other power cell modules in the stack. In this case, the electronic appliances are connected to the user power outputs 1114 of the master power cell module. The master power cell module can be the top power cell module, as one example, or the bottom power cell module, as another example.

In one embodiment, the power cell modules 1102a-1102c are not identical to each other. Instead, some power cell modules may have more or fewer features, different arrangements of components, different numbers of components, different sizes, different power storage and supply capacities, or other types of differences. In this case, the inter-module multi-voltage bus connectors 1112 still ensure that each power cell module 1102a-1102c joins the multi-voltage bus 1108. In one embodiment, one of the multi-voltage power cells is a controlling or master multi-voltage power cell having additional features compared to the other power cell modules in the stack. Some power cell modules in the stack may be relatively featureless in that they do not have user power outputs 1114 and are only used to connected into the stack to provide additional energy capacity to the system 1100. Thus, the stack may include one or master or controlling power cell modules, and one or more simple or slave power cell modules that serve only to provide additional capacity the system 1100, according to one embodiment.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the Figures, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

1-23. (canceled)

24. An automatic transfer plug (ATP 140) configured for use in an environment in which micro-grids (100) are coupled to a utility grid (200) as a main source of electrical power, the micro-grids (100) configured to provide power from the utility grid to loads within a home, office, building, or other structure via a panel box (210) and wall outlets (110) fed power by the utility grid, wherein the panel box contains circuit breakers (220) each disposed between the utility grid and a respective one of the micro-grids (100) and configured to provide power to the respective one of the micro-grids, a first wall outlet (110b) of a first micro-grid (100) configured to mate with a connector of a load and to power the load via the utility grid and the respective one of the circuit breakers disposed between the utility grid and the first micro-grid, the ATP comprising:
an electrical cord having first and second ends;
a first connector disposed at the first end of the electrical cord and configured to mate with the first wall outlet (110b) while the connector of the load is unmated with the first wall outlet;
a second connector disposed at the second end of the electrical cord and configured to mate with a third connector of a secondary power supply (130) that includes at least one battery; and
a microcontroller (142) configured:
to detect an interruption in the utility grid,
to allow the secondary power supply to deliver power to the first micro-grid via the first connector and the first wall outlet to power only one or more loads connected to the first micro-grid in response to detecting the interruption,
to detect that the utility grid is operational, and
to charge the at least one battery from the utility grid via the respective circuit breaker, the first wall outlet, and the first connector in response to detecting that the utility grid is operational.

25. The automatic transfer plug (ATP 140) of claim 24 wherein the first connector is a male plug.

26. The apparatus of claim 24 wherein the primary power supply includes a utility grid.

27. The apparatus of claim 24 wherein the secondary power supply includes at least one battery.

28. The apparatus of claim 24 wherein the secondary power supply includes at least one battery.

29. The automatic transfer plug of claim 24 wherein the microcontroller includes a microprocessor.

30. The automatic transfer plug of claim 24 wherein the microcontroller is configured:
to determine whether the respective one of the circuit breakers is open; and
to allow the secondary power supply to deliver power to the first micro-grid in response to determining that the respective one of the circuit breakers is open.

31. The automatic transfer plug of claim 24 wherein the microcontroller is configured to open the respective one of the circuit breakers before allowing the secondary power supply to deliver power to the first micro-grid.

32. The automatic transfer plug of claim 24 wherein the microcontroller is configured to prevent power from the utility grid from propagating back into the secondary power supply in response to detecting that the utility grid is operational.

33. The automatic transfer plug of claim 24 wherein the secondary power supply lacks protections for preventing power flow from the utility grid to the secondary power supply.

34. The automatic transfer plug of claim 24 wherein the first connector comprises a male plug having:
at least two conductive prongs; and
a protective shroud configured to cover a portion of the conductive prongs not disposed within a wall outlet.

35. The automatic transfer plug of claim 24 wherein the first connector comprises:
a male plug; and
a sensor configured to alert the secondary power supply that the male plug is seated in a wall outlet.

36. The automatic transfer plug of claim 24 wherein the first connector comprises:
a male plug having a plug feature; and
a sensor configured to alert the secondary power supply in response to the plug feature having a proscribed alignment with a feature of a wall outlet.

37. A system including an automatic transfer plug configured for use in an environment in which micro-grids are coupled to a utility grid as a main source of electrical power, the micro-grids configured to provide power from the utility grid to loads within a home, office, building, or other structure via a panel box and wall outlets fed power by the utility grid, wherein the panel box contains circuit breakers each disposed between the utility grid and a respective one of the microgrids and configured to provide power to the respective one of the micro-grids, a first wall outlet of a first micro-grid configured to mate with a connector of a load and to power the load via the utility grid and the respective one of the circuit breakers disposed between the utility grid and the first microgrid, the system comprising:
a backup power source;
a sensor configured to detect that utility grid has ceased supplying power to the micro-grids; and
a microprocessor configured, in response to the sensor detecting that the utility grid has ceased supplying power to the micro-grids:
to disconnect the first micro-grid from the utility grid by opening the respective one of the circuit breakers,
to enable power transfer from the backup power source to the first micro-grid via the first wall outlet,
to detect that the utility grid is operational, and
in response to detecting that the utility grid is operational,
to disable power transfer from the backup power source to the first micro-grid, and
to close the respective one of the circuit breakers to connect the first micro-grid to the utility grid.

38. The system of claim 37, wherein the microprocessor is configured to disconnect the first micro-grid from the utility grid by signaling the respective one of the circuit breakers to open.

39. The system of claim 37 wherein the microprocessor is configured to receive from the respective one of the circuit breakers a signal indicating that the first micro-grid is disconnected from the utility grid.

40. A method for using an automatic transfer plug configured for use in an environment in which micro-grids are coupled to a utility grid as a main source of electrical power, the micro-grids configured to provide power from the utility grid to loads within a home, office, building, or other structure via a panel box and wall outlets fed power by the utility grid, wherein the panel box contains circuit breakers each disposed between the utility grid and a respective one of the microgrids and configured to provide power to the respective one of the micro-grids, a first wall outlet of a first micro-grid configured to mate with a connector of a load and to power the load via the utility grid and the respective one of the circuit breakers disposed between the utility grid and the first microgrid, the method comprising:
detecting that the utility grid has ceased supplying power to the micro-grids;
disconnecting the utility grid from the first micro-grid by opening the respective one of the circuit breakers in response to detecting that utility grid has ceased supplying power to the micro-grids;
enabling power transfer from a backup power source to the first micro-grid via the first wall outlet in response to:
detecting that the utility grid has ceased supplying power to the micro-grids, and
disconnecting the utility grid from the first micro-grid;
detecting that the utility grid has commenced generating power; and
in response to detecting that the utility grid has commenced generating power,
disabling power transfer from the backup power source to the first micro-grid, and
reconnecting the first micro-grid to the utility grid by closing the respective one of the circuit breakers in response to the disabling.

41. The method of claim 40 wherein the respective one of the circuit breakers forms part of the first micro-grid.

42. The method of claim 40 wherein the circuit breaker forms part of the micro-grid.

43. An automatic transfer plug configured for use in an environment in which micro-grids are coupled to a utility grid as a main source of electrical power, the micro-grids configured to provide power from the utility grid to loads within a home, office, building, or other structure via a panel box and wall outlets fed power by the utility grid, wherein the panel box contains circuit breakers each disposed between the utility grid and a respective one of the microgrids and configured to provide power to the respective one of the micro-grids, a first wall outlet of a first micro-grid configured to mate with a connector of a load and to power the load via the utility grid and the respective one of the circuit breakers disposed between the utility grid and the first microgrid, the automatic transfer plug, comprising:
an electrical cord having first and second ends;
a first connector disposed at the first end of the electrical cord and configured to mate with the first wall outlet;
a second connector disposed at the second end of the electrical cord and configured to mate with a third connector of a secondary power supply; and
a controller configured
to detect an interruption in the utility grid,
to determine, in response to detecting the interruption, whether the respective one of the circuit breakers is disconnecting the first micro-grid from the utility grid,
to couple, in response to determining that the respective one of the circuit breakers is disconnecting the first micro-grid from the utility grid, the secondary power supply to the first micro-grid via the first wall outlet,
to detect that the utility grid has commenced generating power, and
in response to detecting that the utility grid has commenced generating power,
to disable power transfer from the secondary power supply the first wall outlet,
to determine whether the respective one of the circuit breakers is connecting the first micro-grid to the utility grid, and
in response to the disabling and determining that the respective one of the circuit breakers is connecting the first micro-grid to the utility grid, to charge at least one battery of the secondary power supply from the utility grid via the respective one of the circuit breakers, the first outlet, the first connector, the second connector, and the third connector.

44. The automatic transfer plug of claim 43 wherein the controller is configured to determine whether the respective one of the circuit breakers is disconnecting the first micro-grid from the utility grid by determining whether the respective one of the circuit breakers is open.

45. The automatic transfer plug of claim 43 wherein the controller is configured to determine whether the respective one of the circuit breakers is connecting the first micro-grid to the utility grid by determining whether the respective one of the circuit breakers is closed.
